(19) United States
(12) Patent Application Publication
(10) Pub. No.: US 2021/0042625 A1
(43) Pub. Date: Feb. 11, 2021

(54) PERFORMANCE OF NEURAL NETWORKS USING LEARNED SPECIALIZED TRANSFORMATION FUNCTIONS

(71) Applicant: ADOBE INC., San Jose, CA (US)

(72) Inventors: Ayush CHOPRA, Delhi (IN); Abhishek SINHA, Nodia (IN); Hiresh GUPTA, Nodia (IN); Mausoom SARKAR, Nodia (IN); Kumar AYUSH, Nodia (IN); Balaji KRISHNAMURTHY, Nodia (IN)

(21) Appl. No.: 16/534,856

(22) Filed: Aug. 7, 2019

(51) Int. Cl. G06N 3/08; G06N 3/04

(52) U.S. Cl. CPC G06N 3/084; G06N 3/0454

(57) ABSTRACT

Methods and systems are provided for facilitating the creation and utilization of a transformation function system capable of providing network agnostic performance improvement. The transformation function system receives a representation from a task neural network. The representation can be input into a composite function neural network of the transformation function system. A learned composite function can be generated using the composite function neural network. The composite function can be specifically constructed for the task neural network based on the input representation. The learned composite function can be applied to a feature embedding of the task neural network to transform the feature embedding. Transforming the feature embedding can optimize the output of the task neural network.

### BACKGROUND

Machine learning or deep learning can be used to train neural networks to perform various tasks. Such tasks can include classifications, retrieval, and recommendations. Accuracy of a system that uses a neural network often depends on how well the neural network is optimized during training. In some instances, optimization can be attempted by performing additional training of the neural network. In other instances, for example, in Support Vector Machine (“SVM”) machine learning based classification, kernels can be used to map input data into high dimensional spaces in an attempt to increase performance. However, difficulties can occur due to the time-consuming nature of performing additional training or in identifying which kernel should be selected and applied (in SVM based classification). As such, conventional methods fail to provide an approach that can automatically optimize any neural network with ease.

### SUMMARY

Embodiments of the present disclosure are directed to a transformation function system capable of optimizing neural networks. In particular, the transformation function system can optimize a neural network based system by generating a customized transformation function specifically learned in relation to the neural network. For instance, a customized transformation function can be created for a particular neural network by learning to optimize representations from the neural network. Optimization of the representations from the neural network can be based on increasing accuracy of the neural network. For example, a customized transformation function can be learned by applying transformation functions to neural network representations and then analyzing the accuracy of the neural network when a transformation function is used. In this way, the transformation function system can generate a customized transformation function specifically learned to optimize the neural network.

### BRIEF DESCRIPTION OF THE DRAWINGS

FIG. 1A depicts an example configuration of an operating environment in which some implementations of the present disclosure can be employed, in accordance with various embodiments.

FIG. 1B depicts an example configuration of an operating environment in which some implementations of the present disclosure can be employed, in accordance with various embodiments.

FIG. 2 depicts an example configuration of an operating environment in which some implementations of the present disclosure can be employed, in accordance with various embodiments of the present disclosure.

FIG. 3 depicts a process flow showing an embodiment for training and/or running a composite function neural network as part of a transformation function system, in accordance with embodiments of the present disclosure.

FIG. 4 depicts a process flow showing an embodiment for implementing a composite function neural network as part of a transformation function system to construct a composite function, in accordance with embodiments of the present disclosure.

FIG. 5 depicts a process flow showing an embodiment for implementing a composite function neural network as part of a transformation function system in conjunction with a task neural network as part of a recommendation system, in accordance with embodiments of the present disclosure.

FIG. 6 depicts a process flow showing an embodiment for implementing a composite function neural network as part of a transformation function system in conjunction with a task neural network as part of a classification system, in accordance with embodiments of the present disclosure.

FIG. 7 illustrates an example structure of a composite function constructed by a composite function neural network that can be used for element-wise transformation on feature embeddings of a task neural network, in accordance with embodiments of the present disclosure.

FIG. 8 illustrates example environment that can be used for training the composite function neural network of a transformation function system to learn a kernel function for SVM based classification, in accordance with embodiments of the present disclosure.

FIG. 9 illustrates example of using a learned transformation function applied to a task neural network, in accordance with embodiments of the present disclosure.

FIG. 10 is a block diagram of an example computing device in which embodiments of the present disclosure may be employed.

### DETAILED DESCRIPTION

Oftentimes, it is desirable for systems that use machine learning or deep learning to have optimized performance. However, it can be difficult to increase performance in such systems. Oftentimes, attempting to increase performance can be computationally expensive (e.g., by performing additional training of a neural network that runs a system). Many conventional approaches to optimizing neural network based systems typically require extensive additional training of the neural network. Other conventional methods for optimizing classification performance, especially in Support Vector Machine (“SVM”) based classification have been limited in success. For example, SVM based classification has relied on the selection of an optimal classic SVM kernel which is often time consuming and difficult. Further, such classic SVM kernels are limited to optimizing SVM based classification. As such, conventional methods fail to provide a standardized approach that can be applied to any neural network with a quantifiable objective output that can provide customized optimization for the neural network without requiring additional training of the network.

Embodiments of the present disclosure are directed to a transformation function system that addresses these problems by providing network agnostic performance improvement. In particular, the transformation function system provides customized transformation functions specifically learned in relation to the feature space of a neural network based system. As such, the transformation functions are capable of transforming neural network based feature embeddings from the neural network based system using the learned transformation functions. Such learned transformation functions can enable optimization of neural network based system (e.g., by increasing accuracy). Neural networks of such systems can include those that output quantifiable objectives. A quantifiable objective is generally a measurable result (e.g., a correct classification, a particular recommendation, retrieving a specific object, etc.).

At a high level, the transformation function system provides a generic framework that generates customized transformation functions capable of optimizing a neural network. This generic framework can be seamlessly integrated for any application domain using an existing neural network to increase performance. Advantageously, the transformation function system is capable of optimizing representations from neural networks without requiring additional training, making the framework computationally efficient. In addition, because the transformation function system is network agnostic, the framework of the system can be used generically to benefit any neural network based feature embeddings trained with a quantifiable objective.

The composite function neural network can be trained for a particular feature space. In particular, once a composite function is generated using the composite function neural network, the composite function can be applied to the particular feature space (e.g., task neural network trained on a specific dataset). For instance, in one embodiment, a composite function can be constructed and then executed to perform an element-wise transformation of learned feature embeddings generated by a recommendation system (e.g., a search and retrieval system that provides recommendations). As another example, in a further embodiment, a composite function can be constructed and then executed as a kernel function in a classification system (e.g., during training of a SVM classification system).

The transformation function system uses reinforcement learning to determine transformation functions applicable in a specific feature space. Such transformation functions can generally be described as composite functions. Composite functions from such a transformation function system can be applied to any machine learning or deep leaning based feature embeddings to optimize the feature embeddings in a neural network. For example, the transformation function system can be used to automatically generate an optimal kernel function to apply to a classification system (e.g., Support Vector Machine based classification). As another example, the transformation function system can be used to determine a function for element-wise transformation of learned visual embeddings of a recommendation system.

The transformation function system can be implemented using one or more neural networks (e.g., a composite function neural network). A neural network generally refers to a computational approach using large clusters of connected neurons. Neural networks are self-learning and trained rather than explicitly programmed such that a generated output of a neural network reflects a desired result. As described herein, the composite function neural network of the transformation function system can be a recurrent neural network. Such a transformation function system can train the recurrent neural network using reinforcement learning based strategy to learn specialized transformations in a feature space. These specialized transformations are capable of improving performance when applied to the feature embeddings from the feature space. In embodiments, the recurrent neural network of the transformation function system can be easily be trained to apply to any machine learning or deep leaning based system that uses neural network based feature embeddings trained with a quantifiable objective.

A composite function neural network of the transformation function system can construct the composite functions. In one embodiment, the composite function neural network can use a search mechanism to construct the composite functions. Such a composite function can be constructed by repeatedly composing core units (e.g., two core units). A core unit can be comprised of two inputs, two unary functions, and one binary function. The two inputs can be representations from, for example, a task neural network. Each of the inputs may be applied using an operand. In particular, an operand can utilize one or more representations (e.g., feature vectors) from a task neural network as input (where the task neural network is the neural network for which the composite function is being generated to increase performance). A unary function can take in a single scalar input and return a single scalar input. A binary function can take in two scalar inputs (e.g., from the two unary functions) and return a single scalar output. To compose a core unit, two operands can be selected that utilize one or more representations (e.g., feature vectors) from the task neural network as input. After selecting the two operands, two unary functions can be selected and applied on the operands. A binary function can be selected and used to combine the outputs of the two unary functions. The resulting combination can then be used as an operand that can be selected in the next group of predictions (e.g., selecting two operands, with one operand the combination from the previous binary function). Two unary functions can then be selected and applied on the two operands, before selecting and using a binary function to combine the outputs of the two unary functions.

When implementing the composite function neural network to construct a composite function, the composite function neural network can be implemented as a recurrent neural network controller. The recurrent neural network controller can be used to predict a single component of a composite function at each time step. This prediction can then be fed back into the controller in the next time step. This process can be repeated until every component of the composite function is predicted by the controller. In implementations, the recurrent neural network controller can construct composite functions that comprise two core units. In particular, to construct a composite function, a core unit can be generated. The core unit can be generated by first selecting two operands and then two unary functions to apply on the operands and finally a binary function that can combine the outputs of the two unary functions. The resulting combination can then be used as an operand that can be selected in the next group of predictions. Each prediction can be carried out using a softmax classifier before being fed into the next time step as an input.

Once a composite function is constructed, the function can be applied to a particular feature space. The effectiveness of the composite function can then be evaluated. For instance, in the feature space of a recommendation system, the effectiveness of a composite function (e.g., transformation function) can be determined using a top-n retrieval performance analysis. A successful retrieval can be indicated when an exact item is found in the top-n retrieved results. As a further instance, in the feature space of a classification system, the effectiveness of a composite function (e.g., custom kernel function) can be determined by conducting an empirical evaluation with the kernel function by performing classification using a dataset.

The subject matter of the present disclosure is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various terms and phrases are used herein to describe embodiments of the present invention. Some of the terms and phrases used herein are described here, but more details are included throughout the description.

As used herein, the term “transformation function system” generally refers to a system that provides a generic framework that generates customized transformation functions capable of optimizing the feature embeddings of a neural network. This generic framework can be seamlessly integrated for any application domain using an existing neural network to increase performance of the existing neural network.

As used herein, the term “composite function neural network” generally refers to a neural network that can learn constructed composite functions related to a task neural network trained on a specific dataset. Composite functions learned using the composite function neural network can be executed to transform feature embeddings in a feature space of the task neural network. The composite function neural network can use reinforcement learning to determine the transformation function applicable in the specific feature space of the task neural network. In some embodiments, the composite function neural network can be implemented as a recurrent neural network controller.

As used herein, the term “task neural network” generally refers to a neural network that performs a particular task. Such tasks can be, for example, classification, recommendation, and/or retrieval. The task neural network can be any neural network that outputs a quantifiable objective. For example, a quantifiable objective is a measurable result (e.g., a correct classification, a particular recommendation, retrieving a specific object, etc.). The task neural network can be trained using a specific dataset. The task neural network can be optimized using transformation functions generated using a composite function neural network.

As used herein, the term “transformation function” generally refers to a learned operation that can be applied in relation to a neural network based system to optimize the output of the neural network based system. For instance, a transformation function can be applied to feature embeddings from a neural network based system. Transformation functions are capable of transforming neural network based feature embeddings from the neural network based system. In particular, a feature embedding can be fed through a learned transformation function to alter the feature embedding in a manner that will optimize the output of the neural network based system (e.g., feature embeddings ƒ₁ and ƒ₂ can be input into the transformation function maximum(er ƒ(ƒ₁), sqrt(ƒ₁+ƒ₂)) to alter the feature embeddings ƒ₁ and ƒ₂ or feature embeddings (x, y) can be input into the transformation function k (x, y)=∥min (sin(x*y), sin(x·y/γ))∥ to alter the feature embeddings (x, y). Reinforcement learning can be used to determine transformation functions applicable in a specific feature space (e.g., the neural network based system trained using a particular dataset). Such learned transformation functions can enable optimization of the neural network based system.

As used herein, the term “composite function” generally refers to a learned transformation function generated using a composite function neural network. Composite functions can be generated for any machine learning or deep leaning based feature embeddings to optimize the feature embeddings in a neural network. For example, the transformation function system can be used to automatically generate a composite function that can be used as an optimal kernel function to apply to a classification system (e.g., Support Vector Machine based classification). As another example, the transformation function system can be used to determine a composite function for element-wise transformation of learned visual embeddings of a recommendation system. Such a composite function can be constructed by repeatedly composing core units (e.g., two core units). A core unit can be comprised of two inputs, two unary functions, and one binary function.

As used herein, the term “feature embeddings” generally refers to representations from the task neural network. As used herein, the “representations” can be one or more feature vectors from the task neural network. Feature embeddings can be taken from any layer in the task neural network. For example, feature embeddings (e.g., feature vectors) can be taken from the penultimate layer of the task neural network. As a further example, the feature embeddings can be taken from the final layer of the task neural network. Feature embeddings can also be the input into the task neural network.

As used herein, the term “feature space” generally refers to a task neural network trained using a specific dataset to perform a particular task. Using representations from the task neural network, the transformation function system can provide customized transformation functions specifically learned in relation to the feature space of a neural network based system (e.g., a system that uses the task neural network).

As used herein, the term “element-wise transformation” generally refers to executing the transformation function on a feature embedding from the task neural network. In particular, a composite function can be applied as an operation to transform feature embeddings from the task neural network.

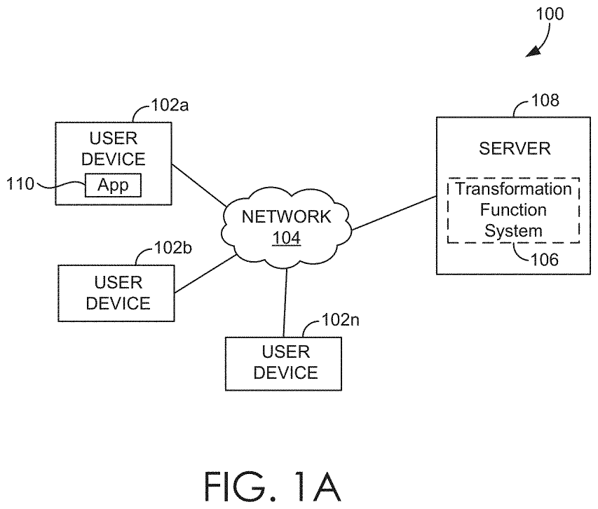

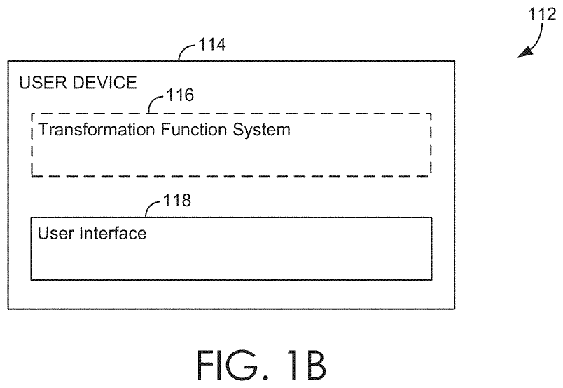

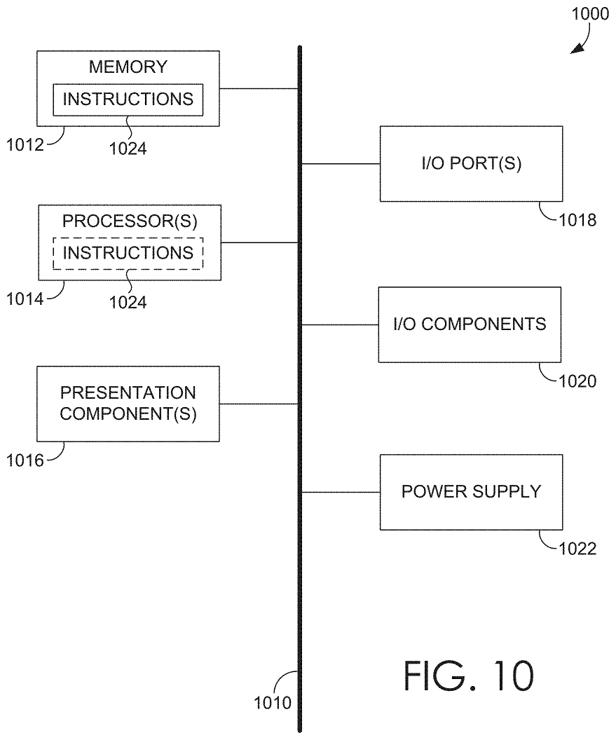

FIG. 1A depicts an example configuration of an operating environment in which some implementations of the present disclosure can be employed, in accordance with various embodiments. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether for the sake of clarity. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, some functions may be carried out by a processor executing instructions stored in memory as further described with reference to FIG. 10.

It should be understood that operating environment 100 shown in FIG. 1A is an example of one suitable operating environment. Among other components not shown, operating environment 100 includes a number of user devices, such as user devices 102a and 102b through 102n, network 104, and server(s) 108. Each of the components shown in FIG. 1A may be implemented via any type of computing device, such as one or more of computing device 1000 described in connection to FIG. 10, for example. These components may communicate with each other via network 104, which may be wired, wireless, or both. Network 104 can include multiple networks, or a network of networks, but is shown in simple form so as not to obscure aspects of the present disclosure. By way of example, network 104 can include one or more wide area networks (WANs), one or more local area networks (LANs), one or more public networks such as the Internet, and/or one or more private networks. Where network 104 includes a wireless telecommunications network, components such as a base station, a communications tower, or even access points (as well as other components) may provide wireless connectivity. Networking environments are commonplace in offices, enterprise-wide computer networks, intranets, and the Internet. Accordingly, network 104 is not described in significant detail.

It should be understood that any number of user devices, servers, and other components may be employed within operating environment 100 within the scope of the present disclosure. Each may comprise a single device or multiple devices cooperating in a distributed environment.

User devices 102a through 102n can be any type of computing device capable of being operated by a user. For example, in some implementations, user devices 102a through 102n are the type of computing device described in relation to FIG. 10. By way of example and not limitation, a user device may be embodied as a personal computer (PC), a laptop computer, a mobile device, a smartphone, a tablet computer, a smart watch, a wearable computer, a personal digital assistant (PDA), an MP3 player, a global positioning system (GPS) or device, a video player, a handheld communications device, a gaming device or system, an entertainment system, a vehicle computer system, an embedded system controller, a remote control, an appliance, a consumer electronic device, a workstation, any combination of these delineated devices, or any other suitable device.

The user devices can include one or more processors, and one or more computer-readable media. The computer-readable media may include computer-readable instructions executable by the one or more processors. The instructions may be embodied by one or more applications, such as application 110 shown in FIG. 1A. Application 110 is referred to as a single application for simplicity, but its functionality can be embodied by one or more applications in practice. As indicated above, the other user devices can include one or more applications similar to application 110. As an example, application 110 can be any application that involves employing neural network based feature embeddings trained with a quantifiable objective.

The application 110 may generally be any application capable of facilitating the exchange of information between the user devices and the server(s) 108 in employing neural network based feature embeddings trained with a quantifiable objective. In some implementations, the application 110 comprises a web application, which can run in a web browser, and could be hosted at least partially on the server-side of environment 100. In addition, or instead, the application 110 can comprise a dedicated application, such as an application having classification, recommendation, and/or retrieval functionality. In some cases, the application 110 is integrated into the operating system (e.g., as a service). It is therefore contemplated herein that “application” be interpreted broadly.

In accordance with embodiments herein, the application 110 can utilize a task neural network. Such a task neural network can be any neural network that outputs a quantifiable objective. In embodiments, a system can be run that incorporates the task neural network, for instance, using application 110. For example the system can be a classification system, a recommendation system, a retrieval system, etc. Application 110 can interact with transformation function system 106. In particular, the transformation function system 106 can provide a customized transformation function specifically learned in relation to the feature space of the neural network based system of application 110. The transformation function system 106 can provide a generic framework that generates customized transformation functions capable of optimizing the task neural network used by application 110. This generic framework can be seamlessly integrated for any application domain (e.g., application 110) using an existing neural network to increase performance.

As described herein, server 108 can facilitate generating a customized transformation function via transformation function system 106. Server 108 includes one or more processors, and one or more computer-readable media. The computer-readable media includes computer-readable instructions executable by the one or more processors. The instructions may optionally implement one or more components of a transformation function system 106, described in additional detail below.

For cloud-based implementations, the instructions on server 108 may implement one or more components of transformation function system 106, and application 110 may be utilized by a user to interface with the functionality implemented on server(s) 108. In some cases, application 110 comprises a web browser. In other cases, server 108 may not be required, as further discussed with reference to FIG. 1B. For example, the components of transformation function system 106 may be implemented completely on a user device, such as user device 102a. In this case, transformation function system 106 may be embodied at least partially by the instructions corresponding to application 110.

Referring to FIG. 1B, aspects of an illustrative transformation function system are shown, in accordance with various embodiments of the present disclosure. FIG. 1B depicts a user device 114, in accordance with an example embodiment, configured to allow for optimizing a task neural network using a transformation function system 116. The user device 114 may be the same or similar to the user device 102a-102n and may be configured to support the transformation function system 116 (as a standalone or networked device). For example, the user device 114 may store and execute software/instructions to facilitate interactions between a user and the transformation function system 116 via the user interface 118 of the user device.

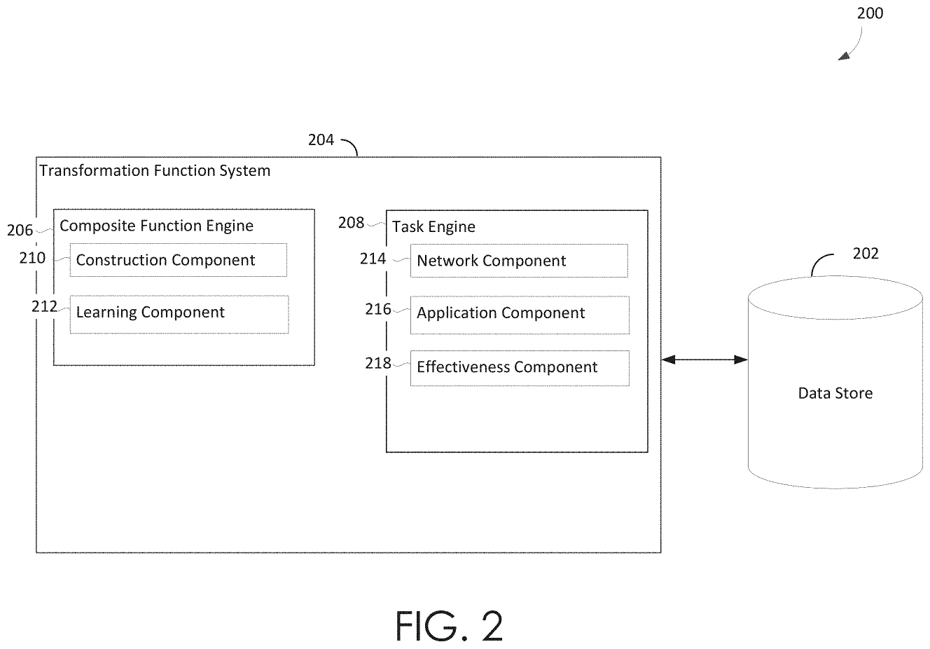

Referring to FIG. 2, aspects of an illustrative environment 200 are shown, in accordance with various embodiments of the present disclosure. As depicted, transformation function system 204 includes composite function engine 206 and task engine 208. The foregoing engines of interpretable transformation function system 204 can be implemented, for example, in operating environment 100 of FIG. 1A and/or operating environment 112 of FIG. 1B. In particular, those engines may be integrated into any suitable combination of user devices 102a and 102b through 102n and server(s) 106 and/or user device 114. While the various engines are depicted as separate engines, it should be appreciated that a single engine can perform the functionality of all engines. Additionally, in implementations, the functionality of the engines can be performed using additional engines and/or components. Further, it should be appreciated that the functionality of the engines can be provided by a system separate from the transformation function system.

Transformation function system 204 can generally be implemented as a general framework for constructing composite functions related to a neural network that performs a particular task (e.g., a task neural network). These composite functions can then be executed to transform feature embeddings in a feature space of the task neural network. Such composite functions can be constructed using a neural network trained using a reinforcement learning based strategy related to a particular task (e.g., a composite function neural network trained in relation to a particular task neural network). For instance, the reinforcement learning based strategy can utilize data from the task neural network in constructing the composite functions. In particular, the data can include representations from the task neural network. In one embodiment, the representations can be one or more feature vectors from the task neural network. As a non-limiting example, the feature vectors can be taken from the penultimate layer of the task neural network. As a further non-limiting example, the feature vectors can be taken from the final layer of the task neural network.

Executing a composite function constructed in relation to a specific neural network that performs a particular task can allow for optimizing the system that performs the task (e.g., using a task neural network) to increase performance. Advantageously, using such a reinforcement learning based strategy allows for optimizing the task neural network of the system without requiring any additional training of the task neural network. In some embodiments, transformation function system 204 can be used to automatically generate an optimal kernel function to apply during the training of a classification system (e.g., Support Vector Machine based classification). In other instances, the transformation function system can be used to determine a function for element-wise transformation of learned visual embeddings of a recommendation system.

In accordance with embodiments described herein, the transformation function system can be implemented using, for example, a composite function neural network. Specifically, the transformation function system can be used to train a composite function neural network and/or utilize a trained composite function neural network to implement a search mechanism to construct composite functions (e.g., that can be applied to any machine learning or deep leaning based feature embeddings to optimize the performance of the system using the task neural network that generates the feature embeddings). Composite function engine 206 can be used to train a composite function neural network in a specific feature space (e.g., to be executed in a system that uses a particular task neural network). To perform this training, composite function engine 206 can interact with task engine 208. Task engine 208 can be used to apply composite functions constructed by the composite function engine 206 to a specific machine learning or deep leaning based feature embeddings to optimize the feature embeddings. In particular, the task engine can operate in conjunction with the composite function engine during training of the composite function neural network to train the network in relation to a specific task. Such tasks can include classification, recommendation, retrieval, etc. Effectiveness of a constructed composite function in relation to the specific task can be used to train the composite function neural network.

In embodiments, task engine 208 can access one or more datasets related to the domain of the particular task neural network for use in training the composite function neural network. Such datasets can be stored, for example, in data store 202. Task engine 208 can be used to apply the composite function constructed using the composite function neural network to the feature embeddings of the particular task neural network. In embodiments, during training of the composite function neural network, task engine 208 can operate in conjunction with composite function engine 206. In particular, composite function engine 206 can be used to construct a composite function using the composite function neural network, task engine 208 can then apply the composite function to feature embeddings to determine effectiveness of the composite function in the feature space, finally, composite function engine 206 can use the effectiveness to train the composite function neural network (e.g., update based on reward).

As shown, a transformation function system can operate in conjunction with data store 202. Data store 202 can store computer instructions (e.g., software program instructions, routines, or services), data, and/or models used in embodiments described herein. In some implementations, data store 202 can store information or data received via the various engines and/or components of transformation function system 204 and provide the engines and/or components with access to that information or data, as needed. Although depicted as a single component, data store 202 may be embodied as one or more data stores. Further, the information in data store 202 may be distributed in any suitable manner across one or more data stores for storage (which may be hosted externally).

In embodiments, data stored in data store 202 can include training data. Training data generally refers to data used to train and or run one or more neural networks, or a portion thereof. As such, training data can include one or more datasets (e.g., a function dataset and a task dataset). The datasets (e.g., function dataset and a task dataset) can be input into data store 202 from a remote device, such as from a server or a user device. These datasets can be stored in a raw form and/or in a processed form. Such datasets (e.g., function dataset and task dataset) can be used for training a neural network (e.g., a composite function neural network).

The function dataset can comprise various operands, unary functions, and binary functions. Such a dataset can be based on a particular task to which the composite function will be applied (e.g., the task the composite function neural network is being trained in relation to). An example dataset can be comprised of operands including x, y, and x+y, unary functions including x, −x, x², |x|, x³, \sqrt{(|x|)}, e^{x}, sin x, cos x, sinh x, cosh x, tanh x, \sqrt{x}, ∥x∥₁, ∥x∥₂, erfx, tan⁻¹ x, σ(x), max(x, 0), min(x, 0), logₑ(1+e^{x}), and binary functions including x₁+x₂, x₁−x₂, x₁·x₂, x₁*x₂, max(x₁, x₂), concat(x₁, x₂), min(x₁, x₂), σ(xᵢ)*x₂, xᵢ. Another example dataset can be comprised of operands including |x−y|, (x+y), (x−y)², ∥x+y∥ᵢ, ∥x+y∥₂, x·y, x*y, γ³, unary functions including x, −x, x², |x|, x³, \sqrt{(|x|)}, e^{x}, sin x, cos x, sinh x, cosh x, tanh x, ∥x∥₁, ∥x∥₂, σ(x), max(x, 0), min(x, 0), logₑ(1+e^{x}), and binary functions including x₁+x₂, x₁−x₂, x₁·x₂, x₁*x₂, max(x₁, x₂), min(x₁, x₂), e^{-|x}^{₁}^{-x}^{_{2|}}, x₁.

The task dataset can data related to a neural network trained for a particular task (e.g., recommendation, classification, etc.). For instance, the task dataset can comprise one or more feature vectors taken from a task neural network. Such feature vectors can be taken from any layer of the task neural network (e.g., penultimate layer, final layer, etc.). For instance, when the task neural network is a recommendation neural network (e.g., as discussed with reference to U.S. application Ser. No. 16/177,243, entitled “Digital Image Search Training using Aggregated Digital Images” which is incorporated herein by reference), two feature vectors can be taken from the task neural network, one from the query trunk (e.g., f1) and one from the target trunk (e.g., f2). As another instance, when the task neural network is a SVM classification system, two feature vectors can be taken from the task neural network.

Data store 202 can also be used to store a neural network during training and/or upon completion of training. Such a neural network can be comprised of one or more neural networks and/or neural network systems. For example, the neural network can include a composite function neural network. Data store 202 can also include pre-trained neural networks related to particular tasks (e.g., recommendation, classification, etc.).

In embodiments, the composite function engine 206 can generally be used to train and/or implement a composite function neural network of the transformation function system. As depicted, composite function engine 206 includes construction component 210 and learning component 212. The foregoing components of composite function engine 206 can be implemented, for example, in operating environment 100 of FIG. 1A and/or operating environment 112 of FIG. 1B. In particular, these components may be integrated into any suitable combination of user devices 102a and 102b through 102n and server(s) 106 and/or user device 114. While the various components are depicted as separate components, it should be appreciated that a single component can perform the functionality of all components. Additionally, in implementations, the functionality of the components can be performed using additional components and/or engines. Further, it should be appreciated that the functionality of the components can be provided by an engine separate from the composite function engine.

Generally, the composite function neural network can comprise a plurality of interconnected nodes with a parameter, or weight, associated with each node. Each node can receive inputs from multiple other nodes and can activate based on the combination of all these inputs, for example, when the sum of the input signals is above a threshold. The parameter can amplify or dampen the input signals. For example, a parameter could be a value between 0 and 1. The inputs from each node can be weighted by a parameter, or in other words, multiplied by the parameter, prior to being summed. In this way, the parameters can control the strength of the connection between each node and the subsequent node. For example, for a given node, a first parameter can provide more weight to an input from a first node, while a second parameter can provide less weight to an input from a second node. As a result, the parameters strengthen the connection to the first node, making it more likely that a signal from the first node will cause the given node to activate, while it becomes less likely that inputs from the second node will cause activation. These parameters can be determined during training of the composite function neural network, as discussed below.

Construction composite 210 constructs composite functions. In an embodiment, construction component 210 uses a recurrent neural network controller architecture to run the composite function neural network. The recurrent neural network controller can be used to predict a single component of a composite function at each time step. This prediction can then be fed back into the controller in the next time step. Each prediction can be carried out using a softmax classifier before being fed into the next time step as an input. This process can be repeated until every component of the composite function is predicted by the controller. In embodiments, the recurrent neural network controller can use ten time steps in constructing the composite function. Using ten time steps can result in constructing a composite function that comprises two core units.

In particular, to construct a composite function, construction component 210 can repeatedly compose core units. First two operands can be selected (e.g., op1 and op2). An operand can utilize one or more representations (e.g., feature vectors) from a task neural network as input. As an example, such operands can be x, y, x+y, |x−y|, (x+y), (x−y)², ∥x+y∥₁, ∥x+y∥₂, x·y, x*y, etc. In such an example, x can be one feature vector and y can be another feature vector. Available operands can be based on the task neural network. For instance, when the task neural network performs the task of retrieval, the operands can be x, y, and x+y. On the other hand, when the task neural network performs the task of classification (e.g., using SVM), the operands can include |x−y|, (x+y), (x−y)², ∥x+y∥₁, ∥x+y∥₂, x·y, x*y, γ³.

After selecting the two operands, two unary functions (e.g., u1 and u2) can be selected and applied on the operands. Unary functions can take in a single scalar input and return a single scalar output. As an example, such unary functions can include x, −x, x², |x|, x³, \sqrt{(|x|)}, e^{x}, sin x, cos x, sinh x, cosh x, tanh x, \sqrt{x}, ∥x∥₁, ∥x∥₂, erfx, tan⁻¹ x, σ(x), max(x, 0), min(x, 0), and logₑ (1+e^{x}). Available unary functions can be based on the task neural network. For instance, when the task neural network performs the task of retrieval, the unary functions can include x, −x, x², |x|, x³, \sqrt{(|x|)}, e^{x}, sin x, cos x, sinh x, cosh x, tanh x, \sqrt{x}, ∥x∥₁, ∥x∥₂, erfx, tan⁻¹ x, σ(x), max(x, 0), min(x, 0), logₑ (1+e^{x}). On the other hand, when the task neural network performs the task of classification (e.g., using SVM), the unary functions can be x, −x, x², |x|, x³, \sqrt{(|x|)}, e^{x}, sin x, cos x, sinh x, cosh x, tanh x, ∥x∥₁, ∥x∥₂, σ(x), max(x, 0), min(x, 0), logₑ (1+e^{x}).

Finally a binary function (e.g., b) can be selected and used to combine the outputs of the two unary functions. In particular, binary functions can take in two scalar inputs (e.g., from the two unary functions) and return a single scalar output. As an example, such binary functions can include x₁+x₂, x₁−x₂, x₁·x₂, x₁*x₂, max(x₁, x₂), concat(x₁, x₂), min(x₁, x₂), σ(x₁)*x₂, etc. Available binary functions can be based on the task neural network. For instance, when the task neural network performs the task of retrieval, the binary functions can include x₁+x₂, x₁−x₂, x₁·x₂, x₁*x₂, max(x₁, x₂), concat(x₁, x₂), min(x₁, x₂), σ(xᵢ)*x₂, x₁. On the other hand, when the task neural network performs the task of classification (e.g., using SVM), the binary functions can include x₁+x₂, x₁−x₂, x₁·x₂, x₁*x₂, max(x₁, x₂), min(x₁, x₂), e^{-|x}^{₁}^{-x}^{₂}^{|}, x₁.

The resulting combination (e.g., b(u1(op1), u2(op2)) can then be used as an operand that can be selected in the next group of predictions. This next group of predictions can include selecting two operands (with one operand as b(u1(op1),u2(op2)), selecting and applying two unary functions on the two operands, and then selecting and using a binary function to combine the outputs of the two unary functions. Constructing a composite function in this fashion results in a composite function that comprises two core units.

Upon constructing a composite function, task engine 208 can receive the composite function to apply to a task neural network. In particular, task engine 208 apply composite functions (e.g., constructed by the composite function engine 206) to specific machine learning or deep leaning based feature embeddings of a task neural network to optimize the feature embeddings.

In embodiments, the task engine 208 can generally be used to train and/or implement a task neural network that can operate in conjunction with the generic framework of the transformation function system that provides customized optimization. As depicted, task engine 208 includes network component 214, application component 216, and effectiveness component 218. The foregoing components of task engine 208 can be implemented, for example, in operating environment 100 of FIG. 1A and/or operating environment 112 of FIG. 1B. In particular, these components may be integrated into any suitable combination of user devices 102a and 102b through 102n and server(s) 106 and/or user device 114. While the various components are depicted as separate components, it should be appreciated that a single component can perform the functionality of all components. Additionally, in implementations, the functionality of the components can be performed using additional components and/or engines. Further, it should be appreciated that the functionality of the components can be provided by an engine separate from the task engine.

Network component 214 runs a task neural network. The task neural network can be a neural network trained to perform a particular task. In embodiments, the task neural network can be any neural network that outputs a quantifiable objective. Such a task neural network can be used to implement a system that provides a product or service (using output from the task neural network). In one example, the task neural network can be a neural network that implements a classification system (e.g., Support Vector Machine based classification). In another example, the task neural network can use a Grid Search Network architecture that uses two inputs (e.g., a query image and a target grid) and has two trunks that are fully convolutional.

Application component 216 receives composite functions (e.g., from composite engine 206) and apply them to a task neural network (e.g., the task neural network run by network component 214). In particular, once a composite function is constructed, the function can be applied to a particular feature space.

Effectiveness component 218 analyzes the effectiveness of the task neural network with the composite function applied. For instance, in the feature space of a recommendation system, the effectiveness of a composite function (e.g., transformation function) can be determined using a top-n retrieval performance analysis. A successful retrieval can be indicated when an exact item is found in the top-n retrieved results. As a further instance, in the feature space of a classification system, the effectiveness of a composite function (e.g., custom kernel function) can be determined by conducting an empirical evaluation with the kernel function by performing classification using a dataset. The effectiveness of the composite function applied to the task neural network can be used to train the composite function neural network.

Learning component 212 uses the effectiveness of the composite function to train the composite function neural network. In particular, during training of the composite function neural network, the network can be updated based on the effectiveness of the composite function(s). During training, the composite function neural network can be updated using reward based on effectiveness (e.g., accuracy) of the task neural network with the composite function applied. In some embodiments, such as in evaluating retrieval performance, reward can be determined using top-n recall. Top-n recall can indicate the number of positives retrieved. In some other embodiments, such as in evaluating classification performance, reward can be determined using the accuracy of the classification. Such reward can then be fed back through the composite function neural network to appropriately train the neural network, for instance, by adjusting the weight of the network connections to optimize the network for maximum reward (e.g., updating the parameters of the network).

The training process can be repeated for a sufficiently large number of cycles. For example, until the composite function neural network converges to a state where accuracy in the task neural network is above a threshold of accuracy. Such accuracy can be determined using a validation set of data. The validation set of data that was not previously used to train the task neural network.

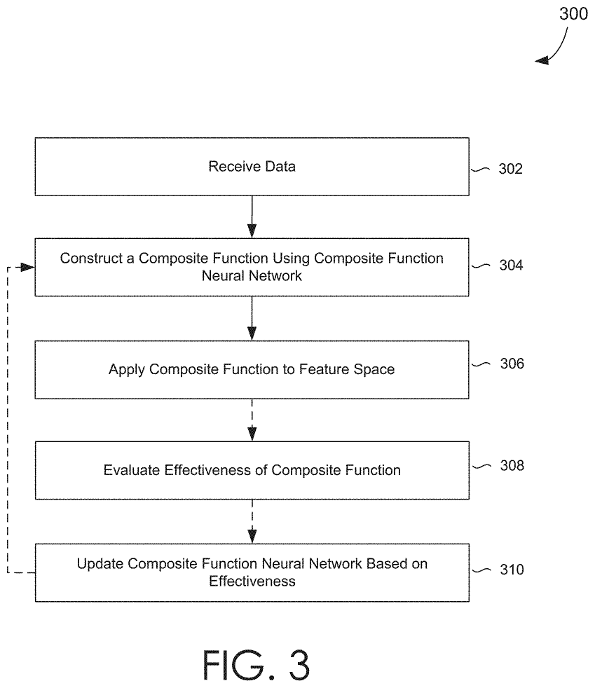

With reference to FIG. 3, a process flow is provided showing an embodiment of method 300 for training and/or running a composite function neural network as part of a transformation function system (e.g., transformation function system 204 of FIG. 2), in accordance with embodiments of the present disclosure. The transformation function system can be comprised of one or more neural networks (e.g., a composite function neural network). Such a transformation function system can train the composite function neural network to construct composite functions applicable in a specific feature space. In this way, the transformation function system can run the composite function neural network in relation to a task neural network that performs a task in the specific feature space (e.g., recommendation or classification). Aspects of method 300 can be performed, for example, by composite function engine 206 in conjunction with task engine 208, as described with reference to FIG. 2.

At block 302, data is received for use in running a composite function neural network. The data can include one or more datasets. For instance, the data can include a function dataset and a task dataset. The function dataset can comprise various operands, unary, and binary functions. Such a function dataset can be based on a particular task to which the composite function will be applied (e.g., the task the composite function neural network is being trained in relation to). The task dataset can be data related to a neural network trained for a particular task (e.g., recommendation, classification, etc.). For instance, the task dataset can comprise one or more feature vectors taken from a task neural network. Such feature vectors can be taken from any layer of the task neural network (e.g., penultimate layer, final layer, etc.). In embodiments, such datasets (e.g., function dataset and task dataset) can be used for training a neural network (e.g., a composite function neural network). In other embodiments, such datasets (e.g., function dataset and task dataset) can be used for running a trained neural network (e.g., a composite function neural network).

At block 304, a composite function is constructed using a composite function neural network. Such a composite function can be constructed to transform feature embeddings in a feature space of a neural network (e.g., a task neural network). To construct the composite function, a recurrent neural network controller architecture can be used. The recurrent neural network controller can be used to predict a single component of a composite function at each time step. This prediction can then be fed back into the controller in the next time step. Each prediction can be carried out using a softmax classifier before being fed into the next time step as an input. This process can be repeated until every component of the composite function is predicted by the controller.

In particular, at block 304, the composite function neural network constructs a composite function by repeatedly composing core units. First two operands can be selected (e.g., op1 and op2). An operand can utilize one or more representations (e.g., feature vectors) from a task neural network as input. After selecting the two operands, two unary functions (e.g., u1 and u2) can be selected and applied on the operands. Unary functions can take in a single scalar input and return a single scalar output. Finally a binary function (e.g., b) can be selected and used to combine the outputs of the two unary functions. In particular, binary functions can take in two scalar inputs (e.g., from the two unary functions) and return a single scalar output. The resulting combination (e.g., b(u1(op1), u2(op2)) can then be used as an operand that can be selected in the next group of predictions. This next group of predictions can include selecting two operands (with one operand as b(u1(op1), u2(op2)), selecting and applying two unary functions on the two operands, and then selecting and using a binary function to combine the outputs of the two unary functions. Constructing a composite function in this fashion can use ten time steps to construct the composite function, resulting in a composite function that comprises two core units.

At block 306, a composite function is applied to the feature space. In particular, the composite function (e.g., constructed using the composite function neural network at block 304) can be applied to specific machine learning or deep leaning based feature embeddings of a task neural network. Such a task neural network can be any neural network that outputs a quantifiable objective. The general goal of applying such a composite function to the feature embeddings of the task neural network is to optimize the feature embeddings. Optimizing the feature embeddings of the task neural network can result in increased performance of a system that used the task neural network (e.g., recommendation system, classification system, etc.). For instance, optimizing the feature embeddings of the task neural network can result in a more accurate output quantifiable objective (e.g., a retrieved image, an assigned classification, etc.).

In some instances, for example, during training of the composite function neural network, the method proceeds to block 308 where the effectiveness of a composite function is evaluated. Effectiveness of the composite function can be determined using the accuracy of the optimized feature embeddings of the task neural network (e.g., optimized using the composite function). For instance, effectiveness can be determined by analyzing the performance of the system that run the task neural network (e.g., classification system, recommendation system). As an example, in the feature space of a recommendation system, effectiveness of a composite function (e.g., transformation function) can be determined using a top-n retrieval performance analysis. A successful retrieval can be indicated when an exact item is found in the top-n retrieved results. As another example, in the feature space of a classification system, the effectiveness of a composite function (e.g., custom kernel function) can be determined by conducting an empirical evaluation with the kernel function by performing classification using a dataset.

In some instances, for example, during training of the composite function neural network, the method proceeds to block 310 where the composite function neural network is updated based on effectiveness. In particular, the effectiveness of the composite function applied to the task neural network (e.g., determined at block 308) can be used to update the composite function neural network. One manner that can be used to update the composite function neural network is using reward based on effectiveness (e.g., accuracy) of the task neural network with the composite function applied. Such reward can then be fed back through the composite function neural network to appropriately train the neural network, for instance, by adjusting the weight of the network connections to maintain and/or increase the value of the reward (e.g., updating the parameters of the network).

Blocks 304 and 310 can be repeated for a sufficiently large number of cycles. For example, training and updating of the composite function neural network can continue until the network converges to a state where accuracy in the task neural network is above a predefined threshold of accuracy. Such accuracy can be determined using a validation set of data. The validation set of data that was not previously used to train the task neural network.

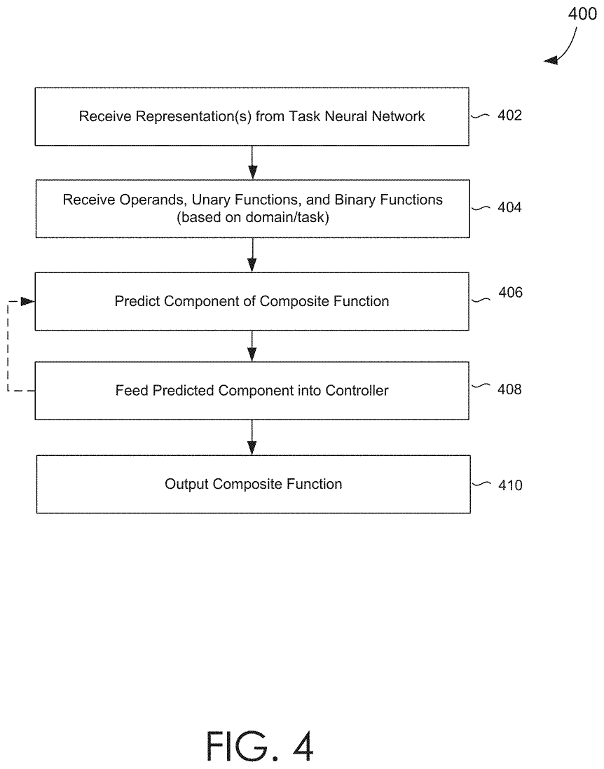

With reference to FIG. 4, a process flow is provided showing an embodiment of method 400 for implementing a composite function neural network as part of a transformation function system (e.g., transformation function system 204 of FIG. 2) to construct a composite function, in accordance with embodiments of the present disclosure. The transformation function system can be comprised of one or more neural networks (e.g., a composite function neural network). In particular, the transformation function system can implement a composite function neural network trained to construct composite functions specialized for specific machine learning or deep leaning based feature embeddings (e.g., from a task neural network). Applying these specialized composite functions to the feature embeddings can optimize the performance of a system that uses the feature embeddings (e.g., generated using a task neural network). Aspects of method 400 can be performed, for example, by composite function engine 206, as described with reference to FIG. 2

At block 402, a representation from a task neural network is received. The representation can be one or more feature vectors from the task neural network. Such feature vectors can be taken from any layer of the task neural network (e.g., penultimate layer, final layer, etc.). The task neural network can be a neural network trained to perform a particular task (e.g., recommendation, classification, etc.).

At block 404, operands, unary, and binary functions are received. The received operands, unary, and binary functions can be based on the task neural network for which the composite function neural network is being trained to construct a composite function. One example of received operands, unary, and binary functions can include operands: x, y, and x+y, unary functions: x, −x, x², |x|, x³, \sqrt{(|x|)}, e^{x}, sin x, cos x, sinh x, cosh x, tanh x, \sqrt{x}, ∥x∥₁, ∥x∥₂, erfx, tan⁻¹ x, σ(x), max(x, 0), min(x, 0), logₑ(1+e^{x}), and binary functions: x₁+x₂, x₁−x₂, x₁·x₂, x₁*x₂, max(x₁, x₂), concat(x₁, x₂), min(x₁, x₂), σ(x₁)*x₂, x₁. Another example of received operands, unary, and binary functions can include operands: |x−y|, (x+y), (x−Y)², ∥x+y∥ᵢ, ∥x+y∥₂, x·y, x*y, γ³ unary functions: x, −x, x², |x|, x³, \sqrt{(|x|)}, e^{x}, sin x, cos x, sinh x, cosh x, tanh x, ∥x∥₁, ∥x∥₂, σ(x), max(x, 0), min(x, 0), logₑ (1+e^{x}), and binary functions: x₁+x₂, x₁−x₂, x₁·x₂, x₁*x₂, max(x₁, x₂), min(x₁, x₂), e^{-|x}^{₁}^{-x}^{_{2|}}, x₁.

At block 406, a component of the composite function is predicted. In embodiments, a recurrent neural network controller architecture can be used to run the composite function neural network to predict components of the composite function. For instance, the recurrent neural network controller can predict a single component of a composite function at each time step.

First two operands can be selected (e.g., op1 and op2). An operand can utilize one or more representations (e.g., feature vectors) from a task neural network as input. As an example, an such operands can be x, y, x+y, |x−y|, (x+y), (x−y)², ∥x+y∥₁, ∥x+y∥₂, x·y, x*y, etc. In such an example, x can be one feature vector and y can be another feature vector. Available operands can be based on the task neural network. For instance, when the task neural network performs the task of retrieval, the operands can be x, y, and x+y. On the other hand, when the task neural network performs the task of classification (e.g., using SVM), the operands can include |x−y|, (x+y), (x−y)², ∥x+y∥₁, ∥x+y∥₂, x·y, x*y, γ³.

After selecting the two operands, two unary functions (e.g., u1 and u2) can be selected and applied on the operands. Unary functions can take in a single scalar input and return a single scalar input. As an example, such unary functions can include x, −x, x², |x|, x³, e^{x}, sin x, cos x, sinh x, cosh x, tanh x, \sqrt{x}, ∥x∥₁, ∥x∥2 erfx, tan⁻¹ x, σ(x), max(x, 0), min(x, 0), and logₑ(1+e^{x}). Available unary functions can be based on the task neural network. For instance, when the task neural network performs the task of retrieval, the unary functions can include x, −x, x², |x|, x³, \sqrt{(|x|)}, e^{x}, sin x, cos x, sinh x, cosh x, tanh x, \sqrt{x}, ∥x∥₁, ∥x∥₂, erfx, tan⁻¹ x, σ(x), max(x, 0), min(x, 0), logₑ(1+e^{x}). On the other hand, when the task neural network performs the task of classification (e.g., using SVM), the unary functions can be x, −x, x², |x|, x³, \sqrt{(|x|)}, e^{x}, sin x, cos x, sinh x, cosh x, tanh x, ∥x∥₁, ∥x∥₂, σ(x), max(x, 0), min(x, 0), logₑ(1+e^{x}).

A binary function (e.g., b) can be selected and used to combine the outputs of the two unary functions. In particular, binary functions can take in two scalar inputs (e.g., from the two unary functions) and return a single scalar output. This results in the combination (e.g., b(u1(op1), u2(op2)). As an example, such binary functions can include x₁+x₂, x₁−x₂, x₁·x₂, x₁*x₂, max(x₁, x₂), concat(x₁, x₂), min(x₁, x₂), σ(x₁)*x₂, x₁, e^{-|x}^{₁}^{-x}^{₂}^{|}, x₁, etc. Available binary functions can be based on the task neural network. For instance, when the task neural network performs the task of retrieval, the binary functions can include x₁+x₂, x₁−x₂, x₁·x₂, x₁*x₂, max(x₁, x₂), concat(x₁, x₂), min(x₁, x₂), σ(x₁)*x₂, x₁. On the other hand, when the task neural network performs the task of classification (e.g., using SVM), the binary functions can include x₁+x₂, x₁−x₂, x₁·x₂, x₁*x₂, max(x₁, x₂), min(x₁, x₂), e^{-|x}^{₁}^{-x}^{₂}^{|}, x₁.

At block 408, the predicted component is fed into a recurrent neural network controller. For instance, the predicted component can be fed back into the recurrent neural network controller in the next time step. Each prediction can be carried out using a softmax classifier before being fed into the next time step as an input. This process can be repeated until every component of the composite function is predicted by the controller. In embodiments, the recurrent neural network controller can use ten time steps in constructing the composite function. Using ten time steps can result in constructing a composite function that comprises two core units.

Blocks 406 and 408 can be repeated as necessary. For instance, blocks 406 and 408 can be repeated until the desired number of time steps have been reached (e.g., 10 time steps). As another instance, blocks 406 and 408 can be repeated until the composite function reaches a predefined size (e.g., two core units).

At block 410, a composite function is output. Such a composite function can be a learned transformation function capable of optimizing the feature embeddings of the task neural network. The composite function can be based not only on the task neural network, but also the dataset used to train the task neural network. For example, a task neural network with a GSN architecture that is trained in relation to a Consumer-to-Shop (i.e., Cons-2-Shop) dataset, the composite function constructed by the composite function neural network can be maximum(erf(ƒ₁), sqrt(ƒ₁+ƒ₂)). As another example, a task neural network with a GSN architecture that is trained in relation to an Inshop retrieval dataset, the composite function constructed by the composite function neural network can be log(1+exp(ƒ₁+ƒ₂)). As a further example, a task neural network that is trained in relation to a CARS dataset, the composite function constructed by the composite function neural network can be tan⁻¹ (concat(ƒ₁, 2*ƒ₂, 3*ƒ₃)). In an additional example, a task neural network that uses SVM with a kernel function to map input data trained using a FashionMNIST dataset, the composite function can be used as the kernel function: ϕFashioMNIST(x, y)=∥x*y∥₁+max(x*y, 0). As a example, a task neural network that uses SVM with a kernel function to map input data trained using a MNIST dataset, the composite function can be used as the kernel function: ϕMNIST(x,y)=μmin(sin(x*y), sin(x·y/γ))∥.

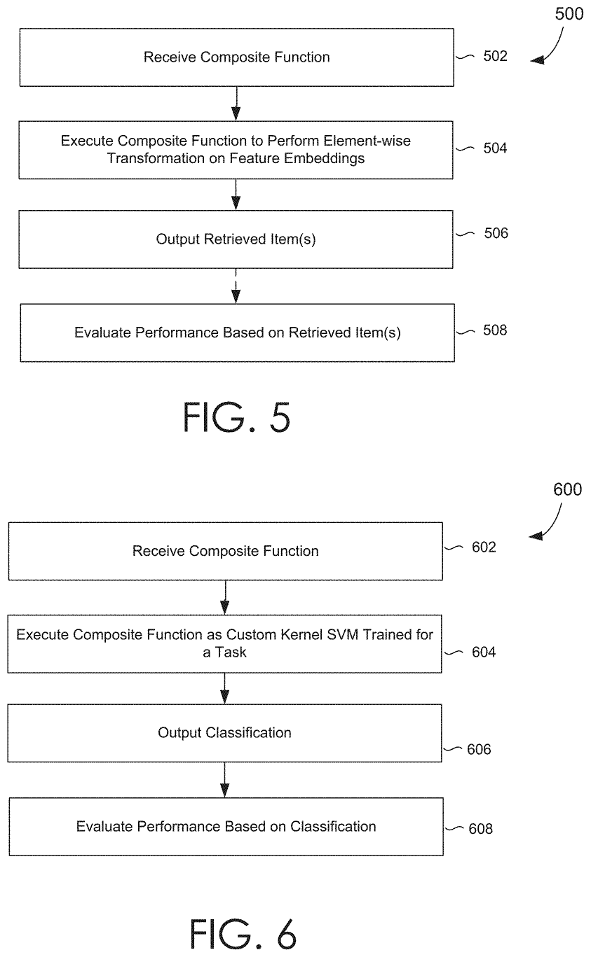

With reference to FIG. 5, a process flow is provided showing an embodiment of method 500 for implementing a composite function neural network as part of a transformation function system (e.g., transformation function system 204 of FIG. 2) in conjunction with a task neural network as part of a recommendation system, in accordance with embodiments of the present disclosure. In particular, the transformation function system can provide a generic framework (e.g., the composite function neural network) that can be used to optimize representations from the task neural network. In embodiments, the composite function neural network can be trained to construct a specialized composite function related to the task neural network. Aspects of method 500 can be performed, for example, by composite function engine 206 in conjunction with task engine 208, as described with reference to FIG. 2.

At block 502, a composite function is received. The composite function can be specifically constructed for the task neural network of the recommendation system. For instance, the composite function can be generated by a composite function neural network to provide customized optimization for the task neural network without requiring additional training of the task neural network. Such a composite function can be generated using a composite function neural network. In particular, the composite function neural network can use a reinforcement learning based strategy to construct the composite function. Constructing such a function can be performed, for example, as discussed with reference to FIG. 4. A composite function can be constructed for the task neural network based on the dataset used to train the task neural network. In this way, the composite function constructed using the composite function neural network can be used to perform an element-wise transformation of learned visual embeddings from the task neural network of the recommendation system.

In an embodiment where the recommendation system uses a task neural network with a GSN architecture that is trained in relation to a Consumer-to-Shop (i.e., Cons-2-Shop) dataset, the composite function constructed by the composite function neural network can be maximum(er ƒ(ƒ₁), sqrt(ƒ₁+ƒ₂)). In such an example composite function, ƒ₁ and ƒ₂ can be representations from the task neural network. In particular, such representations can be feature vectors from a query trunk and a target trunk respectively. Further, erf and sort can refer to the error function and the square root function respectively.

In an embodiment where the recommendation system uses a task neural network with a GSN architecture that is trained in relation to an Inshop retrieval dataset, the composite function constructed by the composite function neural network can be log(1+exp(ƒ₁+ƒ₂)). In an embodiment where the recommendation system uses a task neural network that is trained in relation to a CARS dataset, the composite function constructed by the composite function neural network can be tan⁻¹(concat(ƒ₁, 2*ƒ₂, 3*ƒ₃)). In such an equation, ƒ₁, ƒ₂, and ƒ₃ can be three feature vectors generated by the task neural network.

At block 504, the composite function is executed to perform element-wise transformation on feature embeddings. Such feature embeddings can be generated by the task neural network. For example, the feature embeddings can be feature vectors. In one embodiment, the composite function can be applied to the feature vectors from the penultimate layer of the task neural network. In another embodiment, the composite function can be applied to the feature vectors from the final layer of the task neural network.

At block 506, a retrieved item is output. The retrieved item can be output based on the feature embeddings that have undergone element-wise transformation using the composite function.

In some embodiments, method 500 proceeds to block 508 where performance is evaluated. In particular, performance of the composite function can be evaluated. Performance can be evaluated based on the based on effectiveness (e.g., accuracy) of the task neural network with the composite function applied. In some embodiments, such as in evaluating retrieval performance, reward can be determined using top-n recall. Top-n recall can indicate the number of positives retrieved. In embodiments, the performance can be used to train the composite function neural network (e.g., uses reinforcement learning based on reward).

With reference to FIG. 6, a process flow is provided showing an embodiment of method 600 for implementing a composite function neural network as part of a transformation function system (e.g., transformation function system 204 of FIG. 2) in conjunction with a task neural network, in accordance with embodiments of the present disclosure. In particular, the transformation function system can provide a generic framework (e.g., the composite function neural network) that can be used to optimize representations from the task neural network. In embodiments, the composite function neural network can be trained to construct a specialized composite function related to the task neural network. Aspects of method 500 can be performed, for example, by composite function engine 206 in conjunction with task engine 208, as described with reference to FIG. 2.

At block 602, a composite function is received. The composite function can be specifically constructed for the task neural network of the recommendation system. For instance, the composite function can be generated by a composite function neural network to provide customized optimization for the task neural network without requiring additional training of the task neural network. Such a composite function can be generated using a composite function neural network. In particular, the composite function neural network can use a reinforcement learning based strategy to construct the composite function. Constructing such a function can be performed, for example, as discussed with reference to FIG. 4. A composite function can be constructed for the task neural network based on the dataset used to train the task neural network. In this way, the composite function constructed using the composite function neural network can be used to perform an element-wise transformation of learned visual embeddings from the task neural network of the recommendation system.

In an embodiment where the classification system uses a SVM, the composite function can be a kernel function. When a FashionMNIST dataset is used to train the SVM, such a kernel function can be ϕFashioMNIST(x, y)=∥x*y∥₁+max(x*y, 0). This kernel function can be constructed using, for example, training the SVM using over 1000 FashionMNIST training samples and using accuracy over a separate 500 validation samples as a reward signal to train the control function neural network. When a MNIST dataset is used to train the SVM, such a kernel function can be ϕMNIST(x, y)=∥min(sin(x*y), sin(x·y/γ))∥. This kernel function can be constructed using, for example, training the SVM using over 1000 MNIST training samples and using accuracy over a separate 500 validation samples as a reward signal to train the control function neural network.

At block 604, the composite function is executed to perform element-wise transformation on feature embeddings. In particular, when the task neural network uses SVM, the composite function can be applied as a kernel function. For example, the composite function can be applied as a kernel function (e.g., kernel function K with probability p) to a task neural network using SVM that is undergoing training. Such a task neural network using SVM can be trained with the kernel function to perform with an accuracy (e.g., R).

At block 606 a retrieved item is output. The retrieved item can be output based on the feature embeddings that have undergone element-wise transformation using the composite function.

In some embodiments, method 600 proceeds to block 608 where performance is evaluated. In particular, performance of the composite function can be evaluated. Performance can be evaluated based on the based on effectiveness (e.g., accuracy) of the task neural network with the composite function applied. In some other embodiments, such as in evaluating classification performance, reward can be determined using the accuracy of the classification. Such reward can then be fed back through the composite function neural network to appropriately train the neural network, for instance, by adjusting the weight of the network connections to optimize the network for maximum reward (e.g., updating the parameters of the network). In embodiments, the performance can be used to train the composite function neural network (e.g., uses reinforcement learning based on reward). In embodiments, a policy gradient (e.g., obtained using a REINFORCE algorithm) can be used to compute the gradient of the probability (e.g., p) and scale the probability by accuracy (e.g., R) for use in updating the composite function neural network (e.g., run using a recurrent neural network controller).

The training process between the composite function neural network generating a kernel function and the task neural network applying the kernel function can be repeated for a sufficiently large number of cycles. Using such a constructed kernel function can optimize the task neural network while increasing the computational efficiency of training the task neural network. For example, using the composite function constructed by the composite function neural network as a kernel function over 1000 training samples works better that using a traditional kernel function over 2000 training samples.

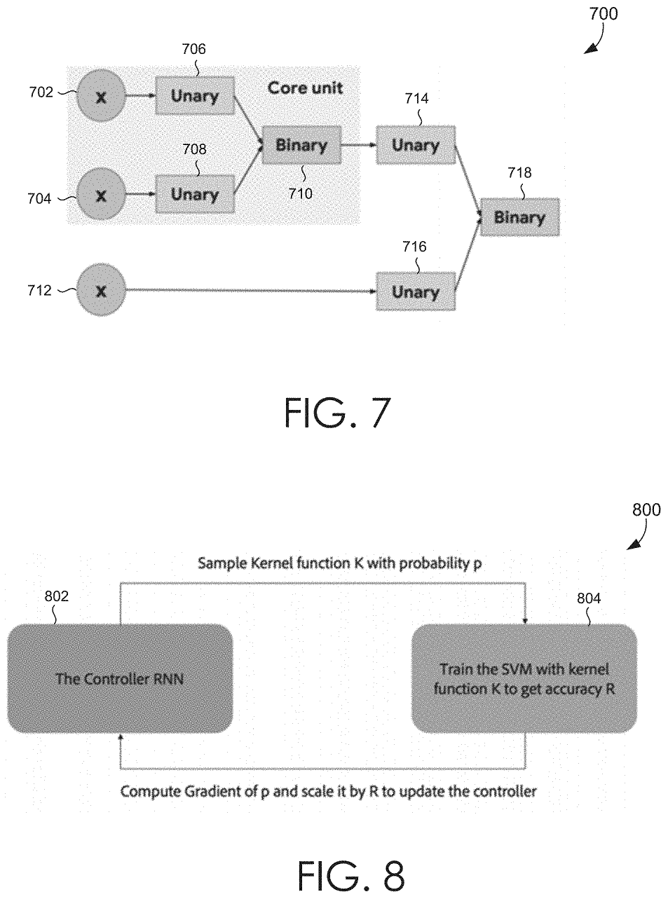

FIG. 7 illustrates a composite function structure 700 of a composite function constructed by a composite function neural network that can be used for element-wise transformation on feature embeddings of a task neural network, in accordance with embodiments of the present disclosure. As depicted, the composite function structure can be a generic framework used to construct a specialized composite function related to the task neural network.

Input 702 can be a representation from a task neural network. A representation can be a feature vector. As a non-limiting example, the feature vectors can be taken from the penultimate layer of the task neural network. As a further non-limiting example, the feature vectors can be taken from the final layer of the task neural network. Input 704 can also be a representation from a task neural network (e.g., a feature vector).

Input 702 and input 704 can be selected operands (e.g., op1 and op2). As an example, such operands can be x, y, x+y, |x−y|, (x+y), (x−y)², ∥x+y∥₁, ∥x+y∥₂, x·y, x*y, etc. In such an example, x can be one feature vector and y can be another feature vector. Available operands can be based on the task neural network. For instance, when the task neural network performs the task of retrieval, the operands can be x, y, and x+y. On the other hand, when the task neural network performs the task of classification (e.g., using SVM), the operands can include |x−y|, (x+y), (x−y)², ∥x+y∥₁, ∥x+y∥₂, x·y, x*y, γ³.

Unary 706 and unary 708 can be unary functions. A unary function can take in a single scalar input and return a single scalar output. As an example, such unary functions can include x, −x, x², |x|, x³, \sqrt{(|x51)}, e^{x}, sin x, cos x, sinh x, cosh x, tanh x, \sqrt{x}, ∥x∥₁, ∥x∥₂, erfx, tan⁻¹ x, σ(x), max(x, 0), min(x, 0), and logₑ(1+e^{x}). Available unary functions can be based on the task neural network. For instance, when the task neural network performs the task of retrieval, the unary functions can include x, −x, x², |x|, x³, \sqrt{(|x|)}, e^{x}, sin x, cos x, sinh x, cosh x, tanh x, \sqrt{x}, ∥x∥₁, ∥x∥₂, erfx, tan⁻¹ x, σ(x), max(x, 0), min(x, 0), logₑ(1+e^{x}). On the other hand, when the task neural network performs the task of classification (e.g., using SVM), the unary functions can be x, −x, x², |x|, x³, \sqrt{(|x|)}, e^{x}, sin x, cos x, sinh x, cosh x, tanh x, ∥x∥1, ∥x∥₂, σ(x), max(x, 0), min(x, 0), logₑ(1+e^{x}).

Binary 710 can be a binary function. A binary function can take in two scalar inputs (e.g., from the two unary functions) and return a single scalar output. As an example, such binary functions can include x₁+x₂, x₁−x₂, x₁·x₂, x₁*x₂, max(x₁, x₂), concat(x₁, x₂), min(x₁, x₂), σ(xᵢ)*x₂, x₁, e^{-|x}^{₁}^{-x}^{_{2|}}, x₁, etc. Available binary functions can be based on the task neural network. For instance, when the task neural network performs the task of retrieval, the binary functions can include x₁+x₂, x₁−x₂, x₁·x₂, x₁*x₂, max(x₁, x₂), concat(x₁, x₂), min(x₁, x₂), σ(x₁)*x₂, x₁. On the other hand, when the task neural network performs the task of classification (e.g., using SVM), the binary functions can include x₁+x₂, x₁−x₂, x₁·x₂, x₁*x₂, max(xᵢ, x₂), min(xᵢ, x₂), e^{-|x}^{₁}^{-x}^{₂}^{|}, x₁.

Binary 710 can generally be represented b(u1(op1), u2(op2). Binary 710 can be used as an operand in the next group of predictions. This next group of predictions can apply two selected unary functions to two operands (where one operand is binary 710 and the other operand input 712). Two unary functions, unary 714 and unary 716, can be applied to the two operands. Binary 718 can then be used to combine the outputs of the two unary functions (unary 714 and unary 716). Constructing a composite function in this fashion results in a composite function that comprises two core units.

FIG. 8 illustrates an example environment 800 that can be used for training a task neural network using SVM with a learned kernel function constructed using a composite function neural network, in accordance with embodiments of the present disclosure. In SVM machine learning based classification, kernels are often used to map input data into high dimensional spaces. In mapping input data into high dimensional spaces, the computational complexity of such systems does not increase significantly during training. Computation efficiency can further be increased using a learned kernel function constructed using a composite function neural network.

Composite function neural network 802 can be used to construct a composite function that can be used as a kernel function. The kernel function can be specifically constructed for task neural network 804 and the dataset being used to train task neural network 804. Task neural network 804 can use SVM machine learning (e.g., to perform classification). The composite function can be constructed, for example, as discussed with reference to FIG. 4. The composite function can be applied as a kernel function (e.g., kernel function K with probability p) to task neural network 804 using SVM that is undergoing training. Task neural network 804 can be trained with the kernel function to perform with an accuracy (e.g., R). A policy gradient (e.g., obtained using a REINFORCE algorithm) can be used to compute the gradient of the probability (e.g., p) and scale the probability by accuracy (e.g., R) for use in updating composite function neural network 802 (e.g., run using a recurrent neural network controller).

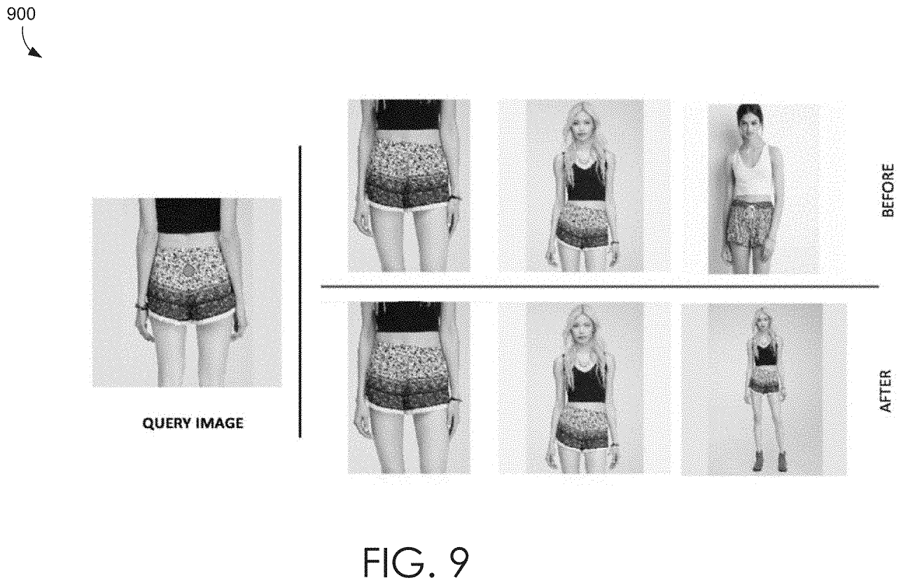

FIG. 9 illustrates an example 900 using a learned transformation function applied to a task neural network, in accordance with embodiments of the present disclosure. Example 900 illustrates the qualitative impact of the learned transformations on retrieval performance (e.g., using an Inshop dataset). The top and bottom rows depict retrieved results for GSN embeddings before and after applying learned transformation functions. The effectiveness of the transformation functions generated using the composite function neural network of the transformation function system can be seen by the fine-grained improvement in the quality of the retrieved images. For instance, the quantitative impact of the learned transformations on retrieval performance can increase the mean average precision of retrieval from 75.2% to 76.4%.

With reference to FIG. 10, computing device 1000 includes bus 1010 that directly or indirectly couples the following devices: memory 1012, one or more processors 1014, one or more presentation components 1016, input/output (I/O) ports 1018, input/output components 1020, and illustrative power supply 1022. Bus 1010 represents what may be one or more busses (such as an address bus, data bus, or combination thereof). Although the various blocks of FIG. 10 are shown with lines for the sake of clarity, in reality, delineating various components is not so clear, and metaphorically, the lines would more accurately be gray and fuzzy. For example, one may consider a presentation component such as a display device to be an I/O component. Also, processors have memory. The inventors recognize that such is the nature of the art and reiterate that the diagram of FIG. 10 is merely illustrative of an exemplary computing device that can be used in connection with one or more embodiments of the present disclosure. Distinction is not made between such categories as “workstation,” “server,” “laptop,” “handheld device,” etc., as all are contemplated within the scope of FIG. 10 and reference to “computing device.”

Computing device 1000 typically includes a variety of computer-readable media. Computer-readable media can be any available media that can be accessed by computing device 1000 and includes both volatile and nonvolatile media, removable and non-removable media. By way of example, and not limitation, computer-readable media may comprise computer storage media and communication media.

Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium which can be used to store the desired information and which can be accessed by computing device 1000. Computer storage media does not comprise signals per se.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. Combinations of any of the above should also be included within the scope of computer-readable media.

Memory 1012 includes computer storage media in the form of volatile and/or nonvolatile memory. As depicted, memory 1012 includes instructions 1024. Instructions 1024, when executed by processor(s) 1014 are configured to cause the computing device to perform any of the operations described herein, in reference to the above discussed figures, or to implement any program modules described herein. The memory may be removable, non-removable, or a combination thereof. Exemplary hardware devices include solid-state memory, hard drives, optical-disc drives, etc. Computing device 1000 includes one or more processors that read data from various entities such as memory 1012 or I/O components 1020. Presentation component(s) 1016 present data indications to a user or other device. Exemplary presentation components include a display device, speaker, printing component, vibrating component, etc.

I/O ports 1018 allow computing device 1000 to be logically coupled to other devices including I/O components 1020, some of which may be built in. Illustrative components include a microphone, joystick, game pad, satellite dish, scanner, printer, wireless device, etc. I/O components 1020 may provide a natural user interface (NUI) that processes air gestures, voice, or other physiological inputs generated by a user. In some instances, inputs may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on computing device 1000. Computing device 1000 may be equipped with depth cameras, such as stereoscopic camera systems, infrared camera systems, RGB camera systems, and combinations of these, for gesture detection and recognition. Additionally, computing device 1000 may be equipped with accelerometers or gyroscopes that enable detection of motion. The output of the accelerometers or gyroscopes may be provided to the display of computing device 1000 to render immersive augmented reality or virtual reality.

Embodiments presented herein have been described in relation to particular embodiments which are intended in all respects to be illustrative rather than restrictive. Alternative embodiments will become apparent to those of ordinary skill in the art to which the present disclosure pertains without departing from its scope.

Various aspects of the illustrative embodiments have been described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features have been omitted or simplified in order not to obscure the illustrative embodiments.

Various operations have been described as multiple discrete operations, in turn, in a manner that is most helpful in understanding the illustrative embodiments; however, the order of description should not be construed as to imply that these operations are necessarily order dependent. In particular, these operations need not be performed in the order of presentation. Further, descriptions of operations as separate operations should not be construed as requiring that the operations be necessarily performed independently and/or by separate entities. Descriptions of entities and/or modules as separate modules should likewise not be construed as requiring that the modules be separate and/or perform separate operations. In various embodiments, illustrated and/or described operations, entities, data, and/or modules may be merged, broken into further sub-parts, and/or omitted.

The phrase “in one embodiment” or “in an embodiment” is used repeatedly. The phrase generally does not refer to the same embodiment; however, it may. The terms “comprising,” “having,” and “including” are synonymous, unless the context dictates otherwise. The phrase “A/B” means “A or B.” The phrase “A and/or B” means “(A), (B), or (A and B).” The phrase “at least one of A, B and C” means “(A), (B), (C), (A and B), (A and C), (B and C) or (A, B and C).”

What is claimed is:

1. One or more computer-readable media having a plurality of executable instructions embodied thereon, which, when executed by one or more processors, cause the one or more processors to perform a method, the method comprising:
receiving a representation from a task neural network;
inputting the representation into a composite function neural network;
generating a learned composite function using the composite function neural network, the composite function related to the task neural network based on the input representation; and
applying the learned composite function to a feature embedding of the task neural network to transform the feature embedding.

2. The media of claim 1, the method further comprising:
generating an output from the task neural network using the transformed feature embedding.

3. The media of claim 2, the method further comprising:
determining effectiveness of the learned composite function based on accuracy of the output from the task neural network; and
updating the composite function neural network based on reward from the determined effectiveness.

4. The media of claim 1, wherein the representation is a feature vector.

5. The media of claim 1, wherein the representation is taken from a penultimate layer of the task neural network.

6. The media of claim 1, wherein the learned composite function is applied as a kernel function to the task neural network.

7. The media of claim 1, wherein the learned composite function comprises two core units, wherein the learned composite function is constructed using a recurrent neural network controller.

8. The media of claim 1, the generating the learned composite function further comprising:
select a first operand and a second operand;
select a first unary function and a second unary function;
apply the first unary function on the first operand and the second unary function on the second operand;
select a first binary function;
apply the first binary function to combine the first unary function and the second unary function;
select a third unary function and a fourth unary function;
apply the third unary function on the combined first unary function and the second unary function and the fourth unary function on a third operand;
select a second binary function;
apply the second binary function to combine the third unary function and the fourth unary function; and
output the learned composite function as the combined third unary function and the fourth unary function.

9. A computer-implemented method comprising:
inputting a representation from a task neural network into a composite function neural network;
constructing a composite function using the composite function neural network, wherein the composite function neural network builds the composite function using repeating core units based on the input representation as an initial input into the composite function;
outputting the composite function from the composite function neural network, the composite function related to the task neural network based on the input representation; and
executing the composite function as an operation to transform a feature embedding of the task neural network.

10. The computer-implemented method of claim 9, further comprising:
generating an output from the task neural network using the transformed feature embedding.

11. The computer-implemented method of claim 9, further comprising:
determining effectiveness of the learned composite function based on accuracy of the output from the task neural network; and
updating the composite function neural network based on reward from the determined effectiveness.

12. The computer-implemented method of claim 11, wherein the updated composited function neural network constructs an updated composite function.

13. The computer-implemented method of claim 9, wherein the representation is a feature vector.

14. The computer-implemented method of claim 9, wherein the representation is taken from a penultimate layer of the task neural network.

15. The computer-implemented method of claim 9, wherein the composite function is applied as a kernel function to the task neural network.

16. The computer-implemented method of claim 9, wherein the repeating core units of the composite function comprise two core units, wherein the composite function is constructed using a recurrent neural network controller.

17. The computer-implemented method of claim 9, the building of the composite function using the repeating core units further comprising:
select a first operand and a second operand, the first and second operand applied in relation to the input representation;
select a first unary function and a second unary function;
apply the first unary function on the first operand and the second unary function on the second operand;
select a first binary function;
apply the first binary function to combine the first unary function and the second unary function;
select a third unary function and a fourth unary function;
apply the third unary function on the combined first unary function and the second unary function and the fourth unary function on a third operand;
select a second binary function;
apply the second binary function to combine the third unary function and the fourth unary function; and
output the learned composite function as the combined third unary function and the fourth unary function.

18. A computing system comprising:
means for receiving a representation from a task neural network, constructing a composite function, and outputting the composite function, the composite function related to the task neural network based on the received representation; and
means for executing the composite function as an operation to transform a feature embedding of the task neural network, and generating an output from the task neural network using the transformed feature embedding.

19. The system of claim 18, further comprising:
means for updating the composite function neural network based on a reward from an effectiveness of the learned composite function determined by the task engine means based on accuracy of the output from the task neural network.

20. The system of claim 18, wherein the composite function comprises two core units, wherein the composite function is constructed using a recurrent neural network controller.
